(19) United States
(12) Patent Application Publication
(10) Pub. No.: US 2006/0161687 A1
(43) Pub. Date: Jul. 20, 2006

(54) Synchronised operation of serially connected devices

(75) Inventor: Marcus Holt, Collingwood (AU)

Correspondence Address: RYAN KROMHOLZ & MANION, S.C., POST OFFICE BOX 26618, MILWAUKEE, WI, 53226, US

(73) Assignee: Opticom Pty Ltd.

(21) Appl. No.: 11/071,829

(22) Filed: Mar. 3, 2005

(30) Foreign Application Priority Data
Jan. 19, 2005 (AU) 2005/200225
Feb. 25, 2005 (AU) 2005/200880

(51) Int. Cl. G06F 15/16

(52) U.S. Cl. 709/248

(57) ABSTRACT

There is disclosed a method of synchronising operation of at least one component of each of a plurality of serially connected devices (1000) connected to a common power source. The method involves sending cycles of serial interrupts (610-619) to each of the serially connected devices (1000), allocating an operation time slot (600,602,604,606,608) to each serially connected device (1006) corresponding to at least one interrupt of each cycle, each at least one allocated time slot being different, and controlling operation of at least one component (222) of each serially connected device to operate only during the time slot allocated to the serially connected device.

### FIELD OF THE INVENTION

The present invention relates to a method of synchronizing operation of serially connected devices, a system of serially connected devices, a serially connectable device and a method of managing communications with serially connected devices.

### BACKGROUND OF THE INVENTION

Computer peripherals can be connected to computers by a number of different types of connections using a number of different protocols. Amongst such connections are connections that enable supply of power to the peripheral device such as USB ports and firewire ports.

We have developed a stackable media device, that is constructed so that a tower of stackable storage devices can be used to store a large quantity of CD-ROMS or other optical media and the entire tower can be serially connected to the same USB port. There is a need to control operation of such devices for example to control power usage in such a stack or of other serially connected devices and to manage communications with such devices.

### SUMMARY OF THE INVENTION

In a first aspect of the invention there is provided a method of synchronising operation of at least one component of each of a plurality of serially connected devices connected to a common power source comprising:

sending cycles of serial interrupts to each of the serially connected devices;

allocating an operation time slot to each serially connected device corresponding to at least one interrupt of each cycle, each at least one allocated time slot being different; and

controlling operation of at least one component of each serially connected device to operate only during the time slot allocated to the serially connected device.

In a second broad aspect there is provided a synchronised system of serially connected devices comprising:

a plurality of serially connected devices;

a computer for sending a cycles of serial interrupts to each of the plurality of connected devices; and

allocation means for allocating operation time slots to each serially connected device corresponding to at least one interrupt, and wherein

each serially connected device comprises control means for monitoring said cycle of interrupts and controlling operation of at least one component to operate only during the time slot allocated to the serially connected device.

In a third broad aspect there is provided a serially connectable device configured to receive cycles of serial interrupts and to be allocated a time slot corresponding to at least one interrupt, said serially connectable device further comprising control means for monitoring said cycle of interrupts and controlling operation of at least one component to operate only during the time slot allocated to the serially connected device.

In a fourth broad aspect there is provided a method of managing communications with a plurality of serially connectable devices comprising a master device and a variable number of slave devices in serial data communication with one another, the method comprising:

a master device continually polling its serial output lines for slave devices; and

each time a new slave device is located until a predetermined maximum number of slave devices is reached, altering the polling in order to poll for additional slave devices, the polling passing through all located slave devices, whereby the master device can determine the current number of connected slave devices.

In a fifth broad aspect there is provided a serially connectable device configured to act as a master device, the serially connectable device comprising:

polling means for continually polling serial output lines of the master device for slave devices, the polling means configured to poll for additional slave devices each time a new slave device is located until a maximum number of slave devices is located, the polling passing through all located slave devices, whereby the master device can determine the current number of slave devices.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a system for storing storage medium in one or more stackable storage device in accordance with one embodiment of the invention;

FIG. 2 is a block diagram schematically illustrating a power management system within one stackable storage device in accordance with one embodiment of the invention;

FIG. 3 is a block diagram schematically illustrating a communication packet structure in accordance with one embodiment of the invention.

FIG. 4 is a ladder diagram schematically illustrating a serial communication interaction for adding units to the stack of media storage devices in accordance with one embodiment of the invention.

FIG. 5 is a flow diagram schematically illustrating a method for communicating between storage device units in accordance with one embodiment of the invention;

FIG. 6 is a schematic diagram illustrating how optosampling is synchronised; and

FIG. 7 is an exploded perspective view of a stack of devices.

### DETAILED DESCRIPTION

Embodiments of the present invention are described herein in the context of a tower of stacked media storage devices. Those of ordinary skill in the art will realize that the following detailed description of the present invention is illustrative only and is not intended to be in any way limiting. Other embodiments of the present invention will readily suggest themselves to such skilled persons having the benefit of this disclosure. In particular, persons skilled in the art will appreciate that the invention can be applied to other serially connectable devices. Reference will now be made in detail to implementations of the present invention as illustrated in the accompanying drawings. The same reference indicators will be used throughout the drawings and the following detailed description to refer to the same or like parts.

Herein, the term “power input port” is used to refer to an input port of a serially connectable device via which the serially connectable device can be supplied with power and control signals, typically from an output port of a computer. Examples of such ports are USB ports and Firewire ports.

The terms “input” and “output” are used to explain the power direction, however communication will be bi directional.

Here the term “serially connectable device” refers to a device adapted to be connected with other devices to form a series of connected devices. Such series being referred to as a series of two or more devices. That is, there may be a minimum of two devices. The maximum number of devices will depend on a variety of parameters, and in the preferred embodiment is five devices. While the series of devices will typically be connected to a serial port, the term “serially connectable” is not intended to imply that the devices must be connected to a serial port.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general purpose machines. The method can be run as a programmed process running on processing circuitry. The processing circuitry can take the form of numerous combinations of processors and operating systems, or a stand-alone device. The process can be implemented as instructions executed by software running on such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Mac OSX available from Apple of Cupertino, Microsoft® Windows® XP and Windows® 2000, Windows ME, Windows 98 SE, all available from Microsoft Corporation of Redmond, Washington, or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

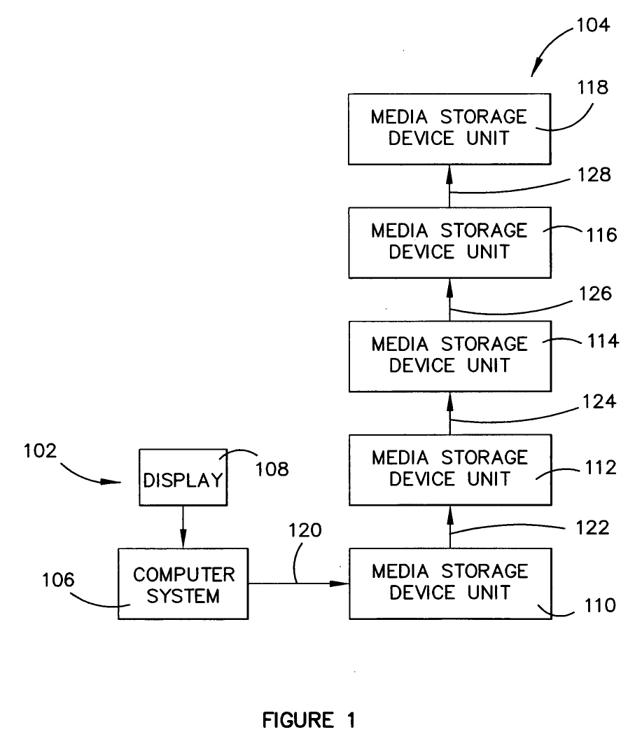

FIG. 1 is a block diagram schematically illustrating a system 102 for storing storage medium, such as optical medium like CDs and DVDs, in a tower 104 of one or more stacked storage devices. The stacked media storage devices 110, 112, 114, 116, and 118 are stacked upon one another as illustrated in FIG. 1 with the storage device 110 as the bottom storage unit. A computer system 106 comprising at least one USB connection (not shown) is attached to a display 108 such as a monitor. The bottom unit 110 is the only storage device from the storage tower (made up of units 110, 112, 114, 116, 118) that is connected to the computer system 106 via a USB cable 120. FIG. 1 illustrates a system having five storage device units 110, 112, 114, 116, 118 stacked on top of one another with unit 110 at the bottom. It will thus be appreciated that the units 110, 112, 114, 116, 118 are serially connected to the USB port of computer system 106.

Those of ordinary skills in the art will recognize that the computer system 106 consists of at least one microcontroller (not shown), memory (not shown), a power source (not shown), and a motherboard (not shown) connected to a USB connection. The computer system will typically be a personal computer.

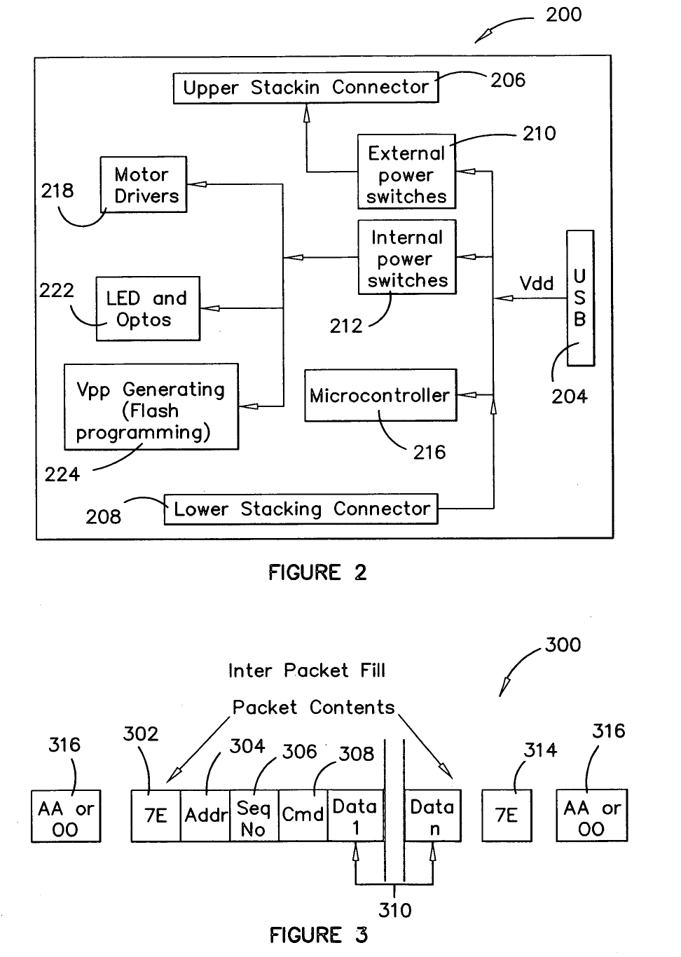

Each media storage device can physically store one or more optical storage medium such as CDs and DVDs. For example, each storage device may include a carousel (not shown) having slots to accommodate the CDs and DVDS. The carousel may be powered by a motor driver and controlled by a microcontroller. A slit opening in the storage device allows a CD or DVD to be inserted and removed. The hardware inside a storage device unit is illustrated and described in more detail in FIG. 2. Each stacked storage devices 110, 112, 114, 116, 118 may be connected to one another in a serial manner through their respective connections 122, 124, 126, and 128. Thus, the tower 104 of stacked storage devices 110, 112, 114, 116, and 118 may be powered through the single USB connector 120 connecting bottom storage device 110 to computer system 106.

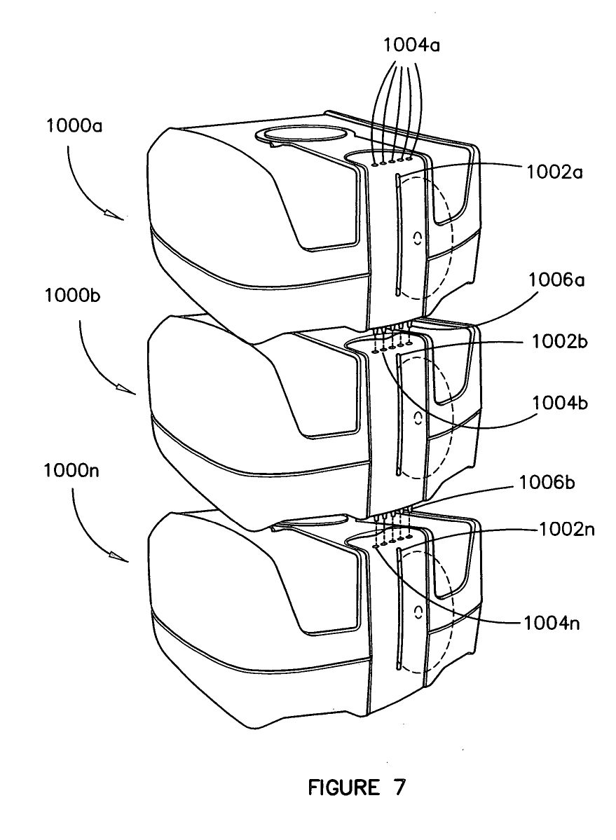

FIG. 7 is an exploded perspective view of a stack of such storage devices 1000. Each storage device 1000a,1000b,1000n has an upper stacking connector 1004a, 1004b, 1004n having five electrical contacts and a lower stacking connector 1006a, 1006b having five pins. Each storage device 1000 has a slot 1002a,1002b,1002n for receiving a disc into carousel (not illustrated). The carousel can receive up to one hundred discs. Each storage device 1000 also has a USB port (not shown).

FIG. 2 is a block diagram schematically illustrating the hardware structure 200 for managing power within each stackable storage device as illustrated in FIG. 1 and FIG. 10. Each storage device includes a USB port 204 for receiving a USB connector as illustrated in FIG. 1. The USB port 204 includes communication and power pins (not shown). The USB port 204 is electrically connected to external power switches 210, internal power switches 212, lower stacking connector 208, and microcontroller 216.

The external power switches 210 switches power to the upper unit via upper stacking connector (USC) 206—i.e. the USC acts as a serial output power port and the external power switch controls whether power is supplied to the output port. The upper stacking connector 206 is electrically connected to the lower stacking connector (LSC) 208 of another unit stacked on top of the present unit. The upper stacking connector 206 has five conductive pins. In the upper units the power comes from the USC 206 of the next lower unit, into the LSC 208 and to the switches. It is only the master, or bottom unit, where the power comes from the USB port 204.

The internal power switches 212 switches power to the present unit from either the LSC or the USB depending on the source of the unit's power. In particular, the internal power switches 212 provides power to motor drivers 218, LED and Opto sensor 222, and Vpp Generation 224. The motor drivers 218 power the carousel motor(not shown) of the present unit. The carousel motor mechanically turns the carousel under the unit's control. The LED provides visual notification to a user whether the storage device unit is powered, and what its current status is. (Busy, idle, errored etc.) The opto sensor 222 senses any addition or removal of an optical disc (e.g. CD or DVD) to the present storage device. The opto sensor 22 also detects movement of the carousel in order to monitor which slot faces the front. The Vpp Generation 224 provides a higher voltage (12V) for the programming of the flash memory in the microcontroller. (Normal operation of the microcontroller and its memory is with a 5V supply.) To program or reprogram the internal flash memory the higher voltage is required. This is typically done when the user downloads a firmware upgrade from the internet and selects to program it into a unit.

The microcontroller 216 is either powered via the USB port 204 (in the case of the a storage device being a master device, in this embodiment the bottom one) or via a lower stacking connector 208 (in the case of a storage device being a slave device, in this embodiment stacked on top of another storage device). That is, the master device is the first device in the series and the only device to receive power directly from the USB port, all subsequent devices in the series of connected devices are slave devices. The microcontroller 216 of the master device control the power usage of the entire tower of storage devices in part by synchronising operation of some components of the storage devices so they do not occur concurrently. Further power control methods are disclosed in Australian patent application no. 2005200225 filed 19 Jan. 2005 the disclosure of which is incorporated herein by reference. The microcontroller of the master device also enables communication with all the devices by allocating addresses as described below. The allocated addresses are also used in the synchronisation method.

In the case where a storage device unit is not powered via USB connector 204, the lower stacking connector 208 provides power to the storage device unit (external power switches 210, internal power switches 212, microcontroller 216). The lower stacking connector 208 is electrically connected to the upper stacking connector of another storage device unit stacked below the present storage device unit. The lower stacking connector 208 has a set of conductive pins.

The stacking connectors also allow each unit to communicate with another. The serial peripheral interface (SPI) bus from the stacking connector may be used for serial communications within a tower of units. Only three data lines (SCK, MISO, MOSI) are required for the SPI connection, thereby minimizing the number of stacking connector pins.

In the preferred embodiment the bottom unit is the logical master and other units within the tower operate as slaves. The normal method of using SPI with multiple slaves (using slave select addressing lines) is not used in this system. Instead, the slaves are configured to listen to master communications and the system uses a layer 2 protocol to frame slave communications.

The master unit is in control of all communications. The master unit sends packets to the first unit then either waits for the response packet from this unit or times out. The master unit determines whether there are any additional slave units by a polling procedure that will be described in further detail below. In summary new slave devices that are attached to the stack have their processor running, but do not provide power to any unit above them in the stack, do not have an address, and do not participate in any serial communications. At specific intervals (in this embodiment, every 2 seconds) the master sends out a “set address” command which only slaves without addresses will interpret. The master knows a new slave has been added if subsequent “get_id” commands sent to the new address get a response. If there is no response, the master assumes there is no new slave and continues as normal. This process relies on the fact that there can only be one new slave unit on the stack at any time due to new units having their upper power connector turned off. Slave units are responsible for working out which eight bits of data comprise a byte, (i.e. synchronizing the byte framing). Slave units synchronise themselves to the byte framing by looking for gaps in the serial clock. Data is sent one bit at a time as a sequence of eight bits, generating eight closely spaced clock pulses. Then there is a gap before the next byte is sent. The slave units synchronise by looking for that gap and then turn on their serial hardware before the next data byte comes through.

The unique way in which SPI is used means that a number of precautions needed to be taken to ensure the physical layer of SPI operates correctly. This includes a system of identifying SPI traffic and adding slave data only when requested by the master, and a means of synchronizing slave communication with the master and/or other slaves. Slaves read all data coming from the master. Slaves know that when the master is talking to a another slave, the other slave is going to be using the shared slave line. They also know no-one else will be using the line when they have received a packet from the master.

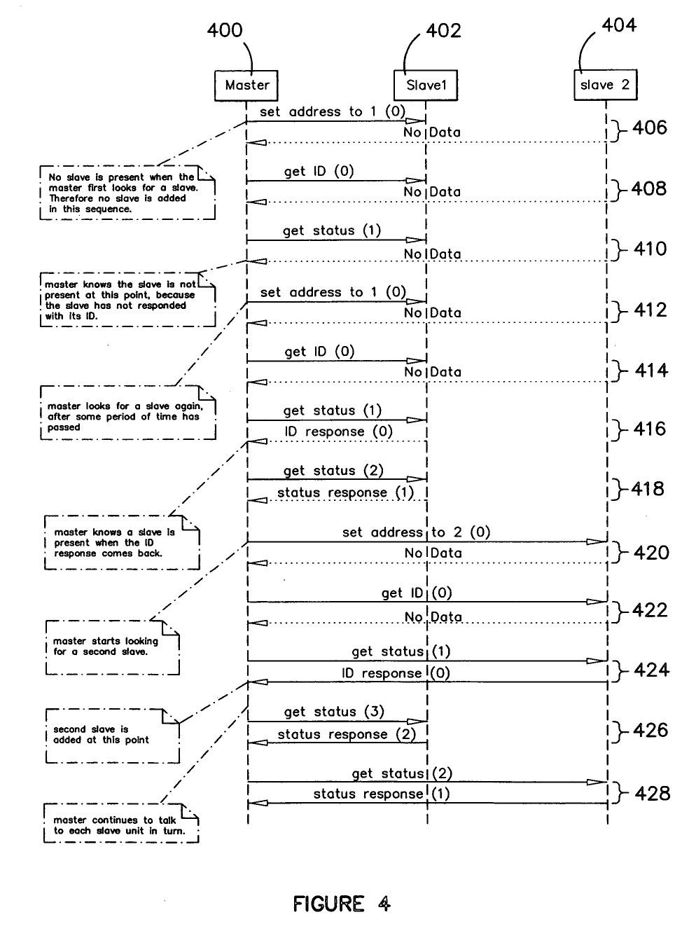

A layer 2 ‘link layer transmission protocol’ for packet transmission has been designed as a means of controlling data transfer within the stack. FIG. 3 illustrates one example of a packet 300 in accordance with one embodiment of the present invention. This protocol ‘wraps’ data bytes in frame delimiters as a means of identifying start and end of packets and includes a system of byte escaping to ensure that a packet delimiter is not placed in the middle of the packet, thus terminating the packet early and includes packet discard for incorrect sequence numbers or repeated packets.

The data to be transferred in the link layer frames is formatted in packets. The format of the packets are to provide a consistent and expandable means of facilitating communications between the master unit and the slaves. The packet start and end are defined by packet delimiters 302 and 314 respectively. The packet contents comprise an address 304, sequence number 306, command 308, then between three and 12 data fields 310. Data fields are not always used, but at least three are always present. This packet format is the same for all packets. Inter-packet gaps are filled by slaves transmitting null bytes between packets, but only because the outputs are tri-stated and the master reads it as a low level. The master sends hex AA bytes as its inter packet gap fill, if a slave somehow misses a delimiter and gets its start and end of packet mixed up, it will see a delimiter followed by an AA, so know that it was out of sync and that was actually the end of a packet. The address field 304 from master to slave indicates which slave is supposed to interpret that packet. From slave to master the address field is used to ensure the correct slave is sending, otherwise discard the packet. When the slave is sending the sequence number field just mirrors whatever the sequence number was on the last command sent from the host PC. This allows the master to see when slaves have received the specified host command. The command field 308 from master to slave indicates an action the slave should take, or what the slave should do with any data bytes that came with that packet. Thus, the command field 308 determines how the data is interpreted. The packet may contain between zero and twelve data bytes. For master to slave communications there are between zero and five bytes used. For slave to master communications there are between three and twelve data bytes used. In a master transmitted packet these parameters completely describe the action required by the unit. For example, if the command was move, the parameters in the data fields 310 would be slot number of the carousel and an eject or retain parameter. In slave to master communications, the data fields return information about the slave status such as whether it is busy performing a command or the current slot number.

The combination of the link layer framing protocol and the packet format make a stable communication system capable of reliably passing commands within the tower and also a means of easily reformatting packets for USB transfer to the host computer. USB transfers are formatted in a very similar fashion to inter-unit SPI communications with the only differences to the data format being the removal of the delimiter bytes, (7E), and the addition of a USB ID field to the start of the packet. USB packets are also always 8 bytes long, so packets that are longer are not sent via USB to the host. There is only one such command which has this problem (the 12 byte return data from a get_id command). To get this data to the host, it has been split up into three separate commands, so that the host PC can retrieve the data as three separate segments.

FIG. 4 is a ladder diagram illustrating a serial communication interaction between the master unit and any slave units in order to add units added to the stack and provide them with addresses. FIG. 4 illustrates how a master unit 400 initiates communications with two slave units 402,404. Communications are duplex so that each rung of a ladder represents a two-way communication. Each line indicates the transmission of a complete packet. Dotted lines are used to indicate that no slave is communicating to the master at that time. The numbers in brackets represent the sequence number that is used in each communication packet. Note that all communications from the slave to the master are to the previous message that the slave received. This is to give the slave enough time to process commands from the master.

Rungs 406 to 410 illustrates the sequence of events that occurs when there is no slaves present. At rung 406 the master 400 turns on its own output power connectors (the upper stacking connector) and sends a set address to one command on the output signal line. No response is received at this stage. At rung 408 the master 400 sends a get_id command on the output line. Having transmitted both the address and the id command allows the slave to reply to acknowledge that it is in address one and to reply with its id and the slave should be able to return the id at rung 410 and accordingly as no id is supplied to the master at rung 410, the master knows that no slave is present at this stage. Note that the next command from the master is to get the status of the slave. With respect to the address, the master's address is 0 and each additional slave's address will increase by one digit 1,2,3 etc. up to the maximum number of slaves, in this embodiment five slaves so the maximum address is 4.

Rungs 412 and 414 represent the master 400 beginning the process of looking for a slave again. This time at rung 416 the master receives an id from the first slave 402 with address 1 and including the id number of the unit. This starts a new cycle of the master 400 continually checking the status of the slave 402 so it sends another get status signal at rung 418. At rung 420 the master 400 starts looking for a second slave 404 and sends a set address command for the second address. The first slave 402 notes that this is not its address because it knows that its address is “1” and ignores the request. Similarly a get_id command is sent by the master 400 at rung 422 which is addressed to the second unit. The master 400 receives an id response at rung 424 and knows to add the second slave 404 to the stack at that point. The master 400 then continues to send status and/or command questions to each unit in turn. As indicated by rungs 426 and 428. The master 400 will also continue to attempt to add further units up to the maximum number of slave devices.

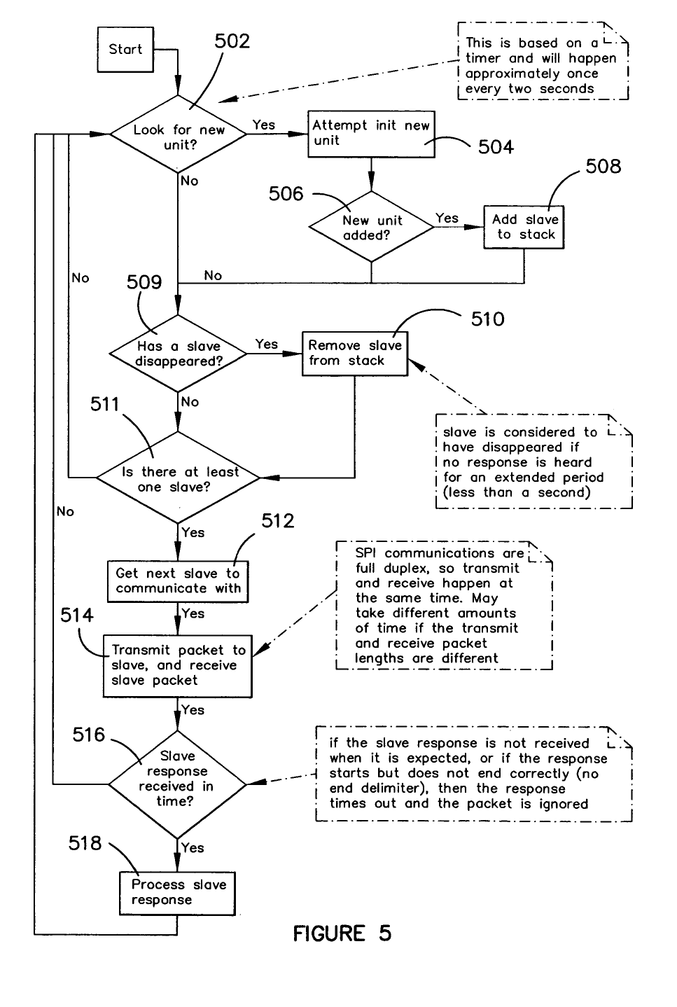

This process is illustrated further in the flow chart of FIG. 5. At step 502 the master 400 decides whether it needs to look for a new unit. If the answer is yes at step 502 it attempts to initiate a new unit. At 506 it determines whether a new unit has been added. If the answer at step 506 is yes it adds a new unit to the stack at 508. If the answer at step 506 is no or the master had previously reached a maximum number of units and hence the answer was no at step 502. At step 509 the master device determines whether a slave has disappeared. A slave is considered to have disappeared if no response is heard for an extended period. If a slave has disappeared it is removed from the stack at step 510. The master 800 then proceeds to step 511 and determines at step 511 whether there is at least one slave. If there is not at least on slave, the master repeats the step of looking for new units. It will also be appreciated that the master 400 will not look for new units if it knows that it has the maximum number of units.

If there is at least one slave at step 511 the master 400 determines the next slave to communicate with at 512. At step 514 it transmits packets to a slave and receives the slave packets.

At step 516 it determines whether a slave response is received in time. If a slave response is not received when expected or the response starts but does not end correctly then the response times out and the packet is ignored and the process of looking for new units starts again. If a unit responds in time at step 518 the slave response is processed.

The addresses allocated to the slaves are used as part of the stack synchronisation protocol. The stack synchronisation protocol is used to ensure the light emitting diodes of the optical sensors of different devices are not on at the same time. Accordingly, it is necessary for each device to know when they can carry out their own optical sampling procedure. This acts to control power usage by the devices. Thus synchronising the optical sampling function avoids too much power being drawn from the shared power source at the same time.

The crystal resonators of each serially connectable device will have some frequency variation. Accordingly, if the devices were merely synchronised once, units would drift apart in time sufficiently to cause problems within a matter of milliseconds. Accordingly, the applicant has developed a method of constantly synchronising the units using the SPI interrupts as the SPI interrupts will occur between 170 and 220 ms intervals and all units within a stack receive the interrupt within a few microseconds of each other.

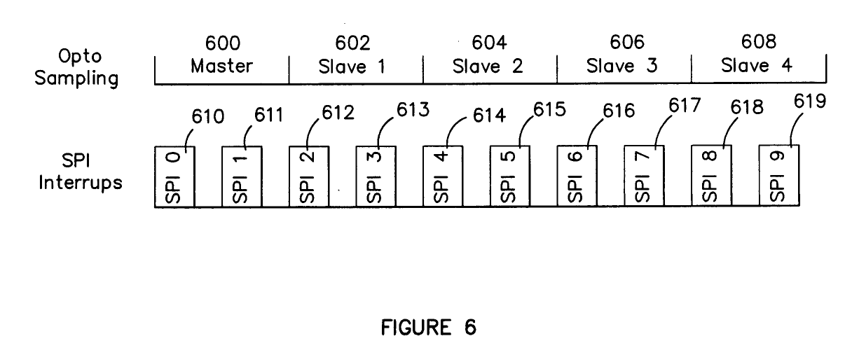

For the devices of the preferred embodiment, sampling the optical inputs takes up to 500 ms to complete and as there are a maximum of five devices that need separate 500 ms time slots to operate in it is necessary to have at least 2.5 ms time period between optical sampling for each unit. As the time taken for these interrupts to execute varies during normal operation a safety margin is added and accordingly the time allowed was set to a total of a 4 ms period and to build this 4 ms period ten separate serial interrupts were used. As illustrated in FIG. 6, the interrupts delineate an SPI time slot. Each unit uses a specific set of the two interrupts as its time slot.

Referring to FIG. 6 it is illustrated that the optical sensing time slot 600 for the master begins at serial interrupt 610 continues through serial interrupt 611 and ends at the beginning of serial interrupt 612 which initiates the optical sampling time slot 602 for the first slave. Thus it will be appreciated that serial interrupts 612 and 613 correspond to time slots 602 for the first slave, serial interrupts 614 and 615 correspond to the time slot 604 for the second slave, serial interrupts 616 and 617 correspond to the time slot 606 for the third slave, and serial interrupts 618 and 619 correspond to the time slot for the fourth slave 608.

To ensure that each unit uses a different time slot for optical sampling each unit needs to know which time slot it is allowed to use. As discussed above when slave units are initialised they are allocated an address. At the same time, the master also advises the slave the current serial interrupt as far as the master is concerned. The slave then takes this number and adds its address multiplied by two to give it a different set of optical time slots to the master and stores this as its current time slot number. This results in each unit in the stack having a different set of two SPI interrupts in which to conduct the optical sensing. The units then use a counter to monitor cycles of interrupts in order to determine which interrupts belong to them and conduct their sensing during these interrupts.

In the above embodiment, each serially connectable stackable media storage device is of identical construction. While this has advantages—e.g. that each device is capable of acting as a master device or a slave device depending on its place in the series of devices and all devices can be manufactured to the same specification persons skilled in the art will appreciate that devices could be designed to operate specifically as master or slave units. In such an embodiment, the master units would not need a lower stacking connector. Such an embodiment would also allow the slave units to be of simpler construction, for example they would not need a USB connection and could be provided with a simpler micro controller.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

We claim:

1. A method of synchronising operation of at least one component of each of a plurality of serially connected devices connected to a common power source comprising:
sending cycles of serial interrupts to each of the serially connected devices;
allocating an operation time slot to each serially connected device corresponding to at least one interrupt of each cycle, each at least one allocated time slot being different; and
controlling operation of at least one component of each serially connected device to operate only during the time slot allocated to the serially connected device.

2. A method as claimed in claim 1, wherein one of said serially connected devices is a master device and each at least one other of the plurality of devices is a slave device, and allocating said at least one interrupt comprises allocating an address to each slave device and each slave device determining its allocated time slot at least on the basis of the allocated address.

3. A method as claimed in claim 2, wherein the master device advises each slave of a serial interrupt of each cycle used by the master to operate the at least one component of the master and each slave determines its allocated time slot as a time slot corresponding to an offset from the advised serial interrupt.

4. A method as claimed in claim 1, wherein each allocated time slot corresponds to two serial interrupts.

5. A method as claimed in claim 1, wherein each cycle comprises ten serial interrupts.

6. A method as claimed in claim 1, wherein operation of each unit is controlled by each serially connected device maintaining a cycle counter in order to monitor for its time slot.

7. A method as claimed in claim 1, wherein the each at least one component is common to each serially connected device.

8. A method as claimed in claim 7, wherein each at least one component is an optical sensing component.

9. A method as claimed in claim 1, wherein the serial interrupt delineate the time slots.

10. A synchronised system of serially connected devices comprising:
a plurality of serially connected devices;
a computer for sending a cycles of serial interrupts to each of the plurality of connected devices; and
allocation means for allocating operation time slots to each serially connected device corresponding to at least one interrupt, and wherein
each serially connected device comprises control means for monitoring said cycle of interrupts and controlling operation of at least one component to operate only during the time slot allocated to the serially connected device.

11. A synchronised system as claimed in claim 10, wherein one of said serially connected devices is a master device and each at least one other of the plurality of devices is a slave device, and said master device being configured to allocate an address to each slave device and each slave device being configured to determine its allocated time slot at least on the basis of the allocated address.

12. A synchronised system as claimed in claim 11, wherein the master device advises each slave of a serial interrupt of each cycle used by the master to operate the at least one component of the master and each slave determines its allocated time slot as a time slot corresponding to an offset from the advised serial interrupt.

13. A synchronised system as claimed in claim 11, wherein each allocated time slot corresponds to two serial interrupts.

14. A synchronised system as claimed in claim 10, wherein each cycle comprises ten serial interrupts.

15. A synchronised system as claimed in claim 10, wherein operation of each unit is controlled by each serially connected device maintaining a cycle counter in order to monitor for its time slot.

16. A synchronised system as claimed in claim 10, wherein the each at least one component is common to each serially connected device.

17. A synchronised system as claimed in claim 16, wherein each at least one component is an optical sensing component.

18. A synchronised system as claimed in claim 10, wherein the serial interrupts delineate the time slots.

19. A serially connectable device configured to receive cycles of serial interrupts and to be allocated a time slot corresponding to at least one interrupt, said serially connectable device further comprising control means for monitoring said cycle of interrupts and controlling operation of at least one component to operate only during the time slot allocated to the serially connected device.

20. A serially connectable device as claimed in claim 19, configured to act as a slave device and to determine its allocated time slot at least on the basis of an allocated address.

21. A serially connectable device as claimed in claim 20, further configured to determine its allocated time slot as a time slot corresponding to an offset from an advised serial interrupt.

22. A serially connectable device as claimed in claim 19, wherein said control means operation device maintains a cycle counter in order to monitor for its time slot.

23. A serially connectable device as claimed in claim 19, wherein the at least one component is an optical sensing component.

24. A method of managing communications with a plurality of serially connectable devices comprising a master device and a variable number of slave devices in serial data communication with one another, the method comprising:
a master device continually polling its serial output lines for slave devices; and
each time a new slave device is located until a predetermined maximum number of slave devices is reached, altering the polling in order to poll for additional slave devices, the polling passing through all located slave devices, whereby the master device can determine the current number of connected slave devices.

25. A method as claimed in claim 24, further comprising the master device allocating an address to each slave as it is located whereby commands can be sent to specific serially connectable devices via the serial lines.

26. A serially connectable device configured to act as a master device, the serially connectable device comprising:
polling means for continually polling serial output lines of the master device for slave devices, the polling means configured to poll for additional slave devices each time a new slave device is located until a maximum number of slave devices is located, the polling passing through all located slave devices, whereby the master device can determine the current number of slave devices.

27. A serially connectable device as claimed in claim 26, wherein the master device is configured to allocate an address to each slave as it is located whereby each command can be sent to specific serially connectable devices.
